(19) United States
(12) Patent Application Publication
(10) Pub. No.: US 2021/0252616 A1
(43) Pub. Date: Aug. 19, 2021

(54) TOOL FOR THE MATERIAL-REMOVING MACHINING OF A WORKPIECE

(71) Applicant: DC SWISS S.A., Malleray (CH)

(72) Inventor: Beat KAUFMANN, Malleray (CH)

(73) Assignee: DC SWISS S.A., Malleray (CH)

(21) Appl. No.: 16/091,308

(22) PCT Filed: Apr. 5, 2017
(86) PCT No.: PCT/EP2017/058140

§ 371 Date: Oct. 4, 2018

(30) Foreign Application Priority Data
Apr. 8, 2016 (EP) 16000807.4

(51) Int. Cl. B23C 5/10; B23G 5/18

(52) U.S. Cl. CPC B23C 5/10; B23G 5/18

(57) ABSTRACT

A tool for material-removing machining of a workpiece has a proximal and a distal end, a shaft for connecting the tool to a drive in the region of the proximal end, and a tool head in the region of the distal end. Cutting elements on the tool head are configured such that they are capable of being introduced into the workpiece to be machined and they are capable of removing a material layer from the workpiece. The cutting elements also include at least one cutting tooth having a cutting tooth ridge and a cutting tooth root, and at least one cutting jaw having a cutting jaw ridge and a cutting jaw root. The ratio between the cutting tooth ridge and the cutting tooth root is smaller, in particular between two and ten times smaller, than the ratio between the cutting jaw ridge and the cutting jaw root.

### TECHNICAL FIELD

The present invention relates to a tool for material-removing machining of a workpiece. Furthermore, the invention relates to a corresponding method for the production of a shaped part by means of material-removing machining of a workpiece, using the tool according to the invention, as well as corresponding resulting shaped parts.

Further aspects of the invention relate to the placement of cooling channels on a tool for material-removing machining of a workpiece, as well as with the geometry and placement of cutting elements on such a tool.

### STATE OF THE ART

In production technology, it is usual, in order to achieve a desired final shape of a workpiece, to remove excess material from a basic shape in order to give the workpiece its final shape. Such production methods are carried out with a great number of prefinished materials or materials left in their original form, such as wood, metal and/or plastic. In most cases, a material-removing tool, which generally consists of a harder material than the workpiece to be machined, is used for this purpose. All material-removing methods have in common that they bring about a reduction in the volume of the workpiece by means of the machining.

Chipping according to DIN 8589 is among the most common material-removing methods. Chipping methods include, among others, also milling, drilling, and grinding. The processes are generally machine-controlled and machine-driven. Aside from the material selection, the geometry and the shape of the tool are decisive for the concrete machining result and the shape achieved. In many areas, and in the production of complex shaped parts, the process takes place in a multi-step method. Thus, for example, a first material-removing step, which undertakes rough pre-shaping of the workpiece, can be carried out with a first tool. A second, more precise tool can then be used to impart a final structure to the pre-shaped form.

Special challenges occur in the case of material-removing machining that comprises particularly small or delicate structures. In precision mechanics, in particular, threads in ranges from 0.3 to 3 mm, for example, must be produced for the watch/clock industry or for medical technology. All material-removing machining processes have in common that the material that is removed accumulates. For this reason, it is one of the challenges of these methods to also ensure suitable material removal transport and, if at all possible, to avoid contamination of the shaped part to be produced with removed material. In the case of a thread, for example, such material can clog the thread and make it unusable.

In the case of both mechanical and manual removal methods, waste heat due to friction frequently occurs as the result of the contact of the tool with the workpiece. Monitoring the waste heat and preventing excessive waste heat from damaging the workpiece or leading to undesirable material modifications is a further challenge of the material-removing machining methods.

EP 2 801 432 A2 (Kaufmann, B.) shows a method and a corresponding tool for the production of a thread or a threaded bore. The milling tool that is used and shown has an essentially triangular profile cross-section. Each “corner” is provided with a comb that has a row of teeth that stand at a specific distance from one another. The combs of the other “corners” also have teeth, specifically at the same distance. In this regard, however, these are disposed offset relative to the teeth of the other combs. As a result, a specifically guided thread can be milled, which is determined not by the shape of the milling tool but rather merely by means of the guidance of the milling tool. However, under some circumstances it can be difficult to transport the chips away, due to the dense tooth placement. Furthermore, depending on the hardness of the material to be machined by such a tool, burr removal can be insufficient under some circumstances. Burrs are particularly undesirable in the case of threads on implants used in medical technology, since they form possible contamination points or surfaces, which can be colonized by deposits.

A thread drill that does without comprehensive tooth placement is shown in DE 20 2007 010 616 U1. The thread milling tool shown is provided for specific thread sizes (M 0.6 to M 6) and has a tool head having a single cutting tooth in its simplest embodiment. Bordering on the cutting tooth, there are two straight-line cutting flanks, which, together with the tooth, define an angle selected in accordance with the thread to be produced. In order to guarantee clean burr removal and material removal, a transition radius is formed between the cutting flank and the adjacent longitudinal cutting edges. This tool is also structured in such a manner that the shape of a resulting thread occurs solely due to the guidance of the tool and not due to the geometry and the placement of the cutting elements on the tool head. However, a disadvantage of this thread is surely the very high production costs, since the processes for production of a transition radius are very complicated. The question also arises: to what extent is it even possible to guarantee such a radius in the corresponding tool, in terms of production technology, in the case of particularly small-scale rotary thread cutters?

Therefore it is definite that a need exists for a tool for material-removing machining of workpieces, which on the one hand can demonstrate the required precision so as to produce even very delicate and small-scale recesses on the corresponding workpieces, and on the other hand can be produced in inexpensive manner and with reliable quality.

### PRESENTATION OF THE INVENTION

It is therefore a task of the present invention to make available a tool for material-removing machining of a workpiece, which tool overcomes at least one disadvantage of what is known. In particular, such a tool is supposed to be made available, which can be produced in simple and efficient manner and is well suited for being used in material-removing machining that requires great precision. In particular, furthermore, such a tool is supposed to be made available, which efficiently removes burrs and chips that occur in material-removing machining from the shape to be produced.

This task was accomplished with a tool in accordance with the characterizing part of the independent claims of the present invention.

One aspect of the present invention relates to a tool for material-removing machining of a workpiece. The tool has a proximal and a distal end. Furthermore, the tool according to the invention comprises a shaft for connecting the tool with a drive in the region of the proximal end, and a tool head in the region of the distal end. The tool according to the invention furthermore comprises cutting elements on the tool head, wherein the cutting elements are structured in such a manner that they are able to penetrate into the workpiece to be machined and able to remove a material layer from the said workpiece. The cutting elements furthermore comprise at least one cutting tooth having a cutting tooth ridge and a cutting tooth root. They furthermore comprise at least one cutting jaw having a cutting jaw ridge and a cutting jaw root. In the case of the tool according to the invention, the ratio between cutting tooth ridge and cutting tooth root is smaller than the ratio between cutting jaw ridge and cutting jaw root. In particular, the ratio is between two and ten times smaller.

In the sense of the present invention, a tool for material-removing machining is suitable if it is designed for bringing a workpiece into a desired shape in a mechanical machining method, in that superfluous material is removed from the workpiece in the form of chips. The material-removing machining can be carried out on any desired material. Particularly preferably, the material-removing machining is carried out on a metallic material. In a particularly preferred embodiment, the material-removing machining according to the invention is milling of a workpiece, in particular of a metallic workpiece. Particularly preferably, this milling of a workpiece is milling of a thread.

In the sense of the present invention, the terms proximal and distal end are to be understood with reference to the orientation of the tool in relation to the workpiece and to the machine. In this sense, the proximal end is the end that is relatively closer to the drive, while the distal end refers to the correspondingly distant end, in other words the end close to the workpiece.

In a special embodiment, the shaft is suitable for connecting the tool with a spindle drive in the region of the proximal end. Fundamentally, a number of drive types are suitable. A drive that can drive the shaft and thereby also the tool head in a rotational movement about its longitudinal axis is particularly well suited. Depending on the type of machining, the drive can also be designed for serving further degrees of freedom. Thus, in a particularly preferred embodiment, the drive can be suited both for driving the tool in a rotational movement about its longitudinal axis and also for driving the tool by a transversal movement along its longitudinal axis. Particularly in the case of thread milling tools, it is furthermore preferred that the drive is able to perform a helical movement about a further central axis in addition to the aforementioned movements. Different degrees of freedom can also be made available by means of different drives. Thus, a linear drive can be provided for transversal movability of the tool or of the workpiece, while a rotational drive can be provided for rotation of the tool.

In the sense of the present invention, a shaft can be suitable for connecting the tool with a drive in the proximal end, if the drive has structural characteristics that allow a force-fit active connection with the drive. In the simplest embodiment, the shaft can be fitted into a mouth of a drive simply by means of its expanse along its longitudinal axis, and held in place mechanically by means of a releasable closure.

In the sense of the present invention, the ratio between cutting tooth ridge and cutting tooth root, respectively between cutting jaw ridge and cutting jaw root can represent a distance ratio. This distance can be defined as follows: The width of the corresponding cutting element in cross-section through the longitudinal axis of the tool in a direction parallel to the longitudinal axis of the tool.

In the sense of the present invention, the cutting tooth ridge can be understood to be the edge that is farthest away, proceeding from the central longitudinal axis, through the center point of the tool of the cutting tooth. Correspondingly, the cutting tooth root can be viewed as being the distance between the two flanks that flank a cutting tooth, in a parallel line to the longitudinal axis, where the distance is the farthest. Cutting jaw ridge and cutting jaw root can be defined analogously. In the sense of this definition, the cutting tooth ridge of a specific cutting tooth is determined by the radius that it defines with reference to the center point, by means of the rotation about the longitudinal axis of the tool through this center point. Analogously, the cutting tooth root is determined by the radius at the location where the cutting tooth begins, in other words where the flanking edges (which run essentially parallel to the longitudinal axis) make a transition into the cutting tooth flanks. If the two cutting tooth flanks have different lengths, two cutting tooth root radii can exist, according to this definition. Analogously, the cutting jaw ridge can also be defined as a radius for the cutting tooth jaw, as the farthest point around the center point, and the cutting jaw root as a radius that is defined from the distance on a perpendicular line to the central longitudinal axis of the tool up to the beginning of the cutting jaw flanks.

In the case of cutting teeth that run radially, the cutting tooth ridge can be defined as a straight line between the two edges that define the cutting tooth in profile, at the point where these edges make a transition into the radius.

In a special embodiment, the cutting tooth ridge and/or cutting jaw ridge runs essentially parallel to the longitudinal axis of the tool. In the sense of the present invention, a cutting tooth ridge and/or cutting jaw ridge can essentially parallel to the longitudinal axis of the tool if it encloses an angle of at most 25°, preferably at most 10°, particularly preferably at most 5° relative to the longitudinal axis.

In a special embodiment, the cutting jaw ridge runs parallel to the longitudinal axis of the tool. Alternatively, the cutting jaw ridge can also enclose an angle relative to the longitudinal axis of the tool. Preferably, the cutting jaw ridge encloses an angle of between 5° and 25° with the longitudinal axis. In the said embodiment with the cutting jaw ridge angled away, this ridge describes a slope or an incline relative to the longitudinal axis, proceeding from the distal end of the tool; in other words, the cutting jaw ridge describes a slope, a face edge is higher than a rear edge, respectively an incline if the rear edge is higher than the face edge. The face edge is the edge of the cutting jaw that is closest when viewed from the distal end, while the rear edge is the opposite one.

In yet another special embodiment, the tool comprises at least two cutting jaws, which have a cutting jaw ridge as described above, which ridge encloses an angle not equal to 0 with the longitudinal axis. Preferably, these are disposed in opposite directions, in other words a first cutting jaw has a cutting jaw ridge having a slope, while a second cutting jaw has a cutting jaw ridge having an incline. Particularly preferably, these are disposed on separate axes parallel to the longitudinal axis and structured in such a manner that they overlap in terms of their rotation circumferences, at least in part, in particular in the region of their relatively lower edge. In this example, therefore, the rear edge of the first cutting jaw would be overlapped by the face edge of the second cutting jaw, in terms of its rotation circumference. With such an arrangement, it can be ensured, for example, that a thread groove created by the cutting tooth is widened and de-burred by the two said cutting jaws at its edges.

In a special embodiment, the ratio between cutting tooth ridge and cutting tooth root is smaller than the ratio between cutting jaw ridge and cutting jaw root by between two and ten times. In other words, at a ratio between cutting tooth ridge and cutting tooth root of 1:10, which means that the cutting tooth ridge is five times shorter than the cutting tooth root; the corresponding ratio between cutting jaw ridge and cutting jaw root is 1:5, which means that the cutting jaw ridge is five times shorter than the cutting jaw root.

In a special embodiment, the height of the cutting tooth is greater than the height of the cutting jaw. In the sense of the invention, the height can be understood as the distance of a perpendicular to the longitudinal axis, between cutting jaw root and cutting jaw ridge.

In a special embodiment, the ratio between cutting tooth ridge and cutting tooth root is in a range of between 1:1.19 and 1:25, preferably of between 1:5 and 1:20, further preferably of between 1:10 and 1:15. In this special embodiment, a cutting tooth ridge with a size of 1 would therefore stand opposite a cutting tooth root with a size of 2 to 25.

In this general presentation of the invention, the size ratios are presented as examples and characterized by their ratio to one another. In addition, the said sizes can be millimeter sizes from one hundredth mm to 1000 mm. Preferably, the sizes of the cutting tooth root move in a range of between 0.1 and 10 mm, for example. The cutting tooth devices are smaller in a corresponding ratio.

In a special embodiment, the tool according to the invention is to produce threads in the size of M0.3 to M6.

Particularly preferably, the tool is a rotary thread cutter for thread sizes of 0.3 to 6 mm, further preferably 0.3 to 3 mm.

In a special embodiment, the ratio between cutting jaw ridge and cutting jaw root is in a range between 1:1 and 1:2, preferably 1:1.9. In a further preferred embodiment, the ratio between cutting jaw ridge and cutting jaw root is in a range of between 1:1.1 and 1:1.75, particularly further preferably of between 1:1.3 and 1:1.5.

In a special embodiment, the cutting tooth is structured in such a manner that it defines a first machining radius during rotation of the tool about its longitudinal axis. In addition, the at least one cutting jaw is structured in such a manner that it defines a second machining radius during rotation of the tool about its longitudinal axis. Further preferably, the first machining radius is greater than the second machining radius. Preferably, this machining radius is the distance of a perpendicular line from the central longitudinal axis of the tool to the edge of a cutting element farthest away from this axis. During operation, this machining radius would define a machining circumference during rotation of the tool about its longitudinal axis, within which circumference material would be removed from a workpiece that gets into this machining circumference. Thus, material can be cut out of the workpiece by means of the cutting teeth, and in a following step, material can also be removed at the edges right away, by means of the contact with the cutting jaw, during the rotational movement of the tool. Because of the comparatively flat cutting jaws, no ridge is formed during this second cutting movement, and the groove cut out by the cutting tooth is cut out precisely and cleanly.

In a special embodiment, all the cutting elements of a tool have overlapping but not congruent machining circumferences during imaginary rotation of the tool about its own longitudinal axis.

In a special embodiment, the tool is structured in such a manner that it defines at least two machining radii during rotation of the tool about its longitudinal axis. Particularly preferably, between 2 and 7, further preferably between 2 and 5 machining radii are defined. A machining radius can be defined, in the sense of the present invention, if a radius as defined above does not define a congruent circumference, respectively does not define a congruent volume of a cutting tooth in its movement, and thereby performs its own machining segment on the workpiece. This can be brought about, on the one hand, by means of machining radii of different heights, on the other hand or supplementally also by means of offset machining radii. The machining radii described are situated in planes that stand perpendicular to the longitudinal axis of the tool. Different machining radii can therefore also occur displaced along the longitudinal axis of the tool. Thus, in a special embodiment, a tool can define two machining circumferences with two cutting teeth that are identical in terms of volume, but in these circumferences the machining radii of the said cutting teeth are displaced on the tool head with regard to one another.

In a special embodiment, the tool is essentially structured to be triangular. In the sense of the present invention, structured to be essentially triangular can be understood to mean that a cross-section through the tool head in a plane that is perpendicular to the longitudinal axis of the tool, the cutting elements are disposed at a distance of approximately 120° from one another, in each instance. In other words, the cross-section in a perpendicular line to the longitudinal axis, through the tool head, can be described an essentially triskelion shape. In a special embodiment, a total of three cutting elements are provided. At least one cutting element is a cutting tooth, and at least one cutting element is a cutting jaw. The further, third cutting element can be a cutting jaw or a cutting tooth. These three cutting elements can be disposed perpendicular to the longitudinal axis on the same cross-sectional plane, or offset relative to one another in the longitudinal direction.

In a special embodiment, the at least one cutting tooth has a face edge and a rear edge. In the sense of the present invention, the face edge can be defined as the edge of the cutting tooth that is distal, in other words facing the workpiece, while the rear edge can be defined as the edge of the cutting tooth that is proximal, in other words facing away from the workpiece. In a special embodiment, only one of the two edges of the cutting tooth is structured for cutting. In a further special embodiment, only the face edge is structured for cutting. This embodiment for cutting can result from the tool geometry, or, in contrast, also from structural characteristics of the edge as such. In a special embodiment, a cutting edge is then such an edge if it leads to removal of material upon contact with the workpiece. The geometry of the tool can be structured in such a manner that always only a front edge, in other words a face edge, engages into the workpiece at a specific cutting tooth and leads to material removal during rotation about the longitudinal axis, while always only the rear edge contacts the material of the workpiece and leads to removal in the case of a further cutting tooth that engages into the existing groove of the first cutting tooth.

In a special embodiment, the workpiece comprises a plurality of cooling channels that extend through the shaft parallel to the longitudinal axis of the tool. Such cooling channels can be simple bores through the length of the shaft in terms of shape. Likewise, it is conceivable that the cooling channels are only formed when a multi-part shaft is joined together. Thus, the shaft can comprise of a shaft body that forms a core of the shaft and extends through the entire longitudinal axis, and a shaft mantle. This shaft mantle or the corresponding shaft core can be structured with recesses that form channels through the shaft in the assembled state. The channels can extend parallel to the longitudinal axis of the shaft. Preferably, the cooling channels are structured in such a manner that they have at least one opening in the distal region, particularly preferably in the vicinity of the tool head. During operation, a cooling fluid can get into the machining zone through the cooling channels, and thereby ensure that overheating of the tool head is prevented. In a special embodiment, the tool comprises one cooling channel, each having one opening, per cutting element. In the case of a tool having three cutting elements, for example, cooling would take place with three cooling channels. In a particularly preferred embodiment, the cooling channels are also oriented in a triangular cross-sectional arrangement relative to the longitudinal axis. Such cooling channels, disposed radially about the center point, in other words the longitudinal axis, would have the advantage that imbalance effects are prevented.

In a special embodiment, the openings of the cooling channels are disposed in such a manner that they come to lie precisely between the cutting elements. In a triangular, triskelion-shaped cross-sectional arrangement, the cooling channels would therefore be disposed at a distance of 120° relative to one another and at a distance of 60° relative to the cutting elements.

In a special embodiment, the shaft narrows toward the tool head, so that a shoulder is formed and the said cooling channels have openings on this shoulder.

In a further special embodiment, the openings are disposed on the shoulder in such a manner that lateral coolant feed is made possible. Particularly preferably, it is thereby made possible that the openings follow the progression of the shoulder and are chamfered, so that exit of cooling fluid can take place laterally.

In a special embodiment, the cooling openings have a half-moon shape, which essentially follows the progression of the tool profile. In the sense of the present invention, such a half-moon-shaped cooling opening has two opening radii that lie opposite one another, which essentially follow the progression of the shaft circumference and are connected with one another by way of a transition radius.

In a special embodiment, the cooling openings are structured as mouths of the cooling channels, in such a manner that the coolant feed runs axially and takes place out of the mouths in a parallel to the longitudinal axis. As a result, a coolant curtain can occur during simultaneous rotation of the tool about its own longitudinal axis during operation, which curtain allows optimal cooling of the material-removing machining.

In a special embodiment, the cooling openings are disposed coaxial to interstices between the cutting elements;
particularly preferably, such interstices as structured as recesses, so-called cutting gaps, which allow material discharge of the material-removing process.

In a special embodiment, the cooling channels, and, connected with them, the cooling openings are disposed about the central longitudinal axis with radial symmetry, at an angular distance, particularly preferably at a distance of 120°.

In a special embodiment, each cutting element is configured on a separate circumferential plane, disposed perpendicular to a longitudinal axis. Alternatively, each cutting element is configured on the same circumferential plane, disposed perpendicular to the longitudinal axis.

In a special embodiment, the tool has a plurality of cutting teeth. At least a first cutting tooth is disposed offset along the longitudinal axis relative to a second cutting tooth, so that the first and the second cutting tooth have a overlapping but not congruent rotation circumferences about the longitudinal axis.

In a special embodiment, the tool is coated with an abrasion-resistant layer. Particularly preferably, the tool head and/or at least the cutting elements is/are coated with an abrasion-resistant layer. Suitable and conceivable abrasion-resistant coatings are polycrystalline diamond layers, polycrystalline boron nitride layers, titanium nitride layers, titanium carbonitride layers, titanium aluminum nitride layers, among others.

In a special embodiment, the cutting elements have a specific predefined distance from the distal end of the tool. In a special embodiment, this distance from the distal end of the tool is measured all the way to the most distal point of the cutting element root, where a side flank of the cutting element forms an edge with the distal end of the tool. In a special embodiment, this edge defines an angle. Particularly preferably, this edge forms an angle of between 91 and 145°. This means that the inside angle of the said cutting element is between 89 and 35°, particularly preferably precisely 60°.

In a special embodiment, the distance from the distal end of each cutting element of a tool is different. In the example of a triangular cross-section, the cutting elements follow one another in their distances from the distal end. A first cutting element is closest to the distal end. A second cutting element follows at a further distance, and a third cutting element is farthest away from the distal end. As a variant of this, the second cutting element is the cutting element that is farthest away from the distal end, viewed in the clockwise direction, proceeding from the first cutting element. In a particularly preferred embodiment, this sequence is formed by cutting jaw, cutting tooth, and cutting tooth.

In a special embodiment, cutting elements that are situated on the same longitudinal plane parallel to the longitudinal axis are separated from one another by a notch.

In a special embodiment, the cutting teeth are no longer toothed at the ridges. In a special embodiment, the cutting elements of the tool head are composed of a tooth and a jaw, preferably each on a separate longitudinal axis, parallel to the central longitudinal axis, in each instance.

In a special embodiment, the cutting elements of the tool head are composed of a tooth and two jaws, preferably each on a separate longitudinal axis, parallel to the central longitudinal axis, in each instance.

In a special embodiment, the cutting elements of the tool head are composed of two cutting teeth and a cutting jaw, preferably each on a separate longitudinal axis, parallel to the central longitudinal axis, in each instance.

In a special embodiment, the cutting elements on the tool head are composed of three cutting teeth and two cutting jaws.

In the sense of the present application, a(n) parallel to the central longitudinal axis can form a cutting edge. The corresponding cutting elements are then situated on a separate corresponding parallel to the central longitudinal axis, if the radius that they define with their corresponding cutting jaw ridge or cutting tooth ridge relative to the central longitudinal axis encloses an angle relative to the corresponding radius of another cutting element.

In a special embodiment, the cutting teeth and the cutting jaws are each disposed on the tool head on different longitudinal planes parallel to the longitudinal axis. By means of this arrangement, the result can be achieved that a cutting jaw carries out the corresponding abrasion of the groove edges of the incision that has been made, upstream in the rotation pattern, in other words after engagement of the cutting tooth. Of course, the cutting jaw can also engage and remove material ahead of the cutting tooth.

With the tool according to the invention, a tool for material-removing machining of a workpiece has been made available, which can be used in simple and versatile manner, and is cost-advantageous in terms of its production. For a person skilled in the art, it is obvious that certain parameters such as material selection, selection of the coating, and placement of the cutting teeth or cutting jaws can be selected in view of the desired shaped part and the materials to be machined. It is also obvious to a person skilled in the art that all the said embodiments can be implemented in a tool according to the invention in any desired combination, as long as they do not explicitly mutually exclude one another.

A further aspect of the present invention relates to a method for production of a shaped part by means of material-removing machining of a workpiece using a tool according to the invention as has been described. To carry out the method, the tool is brought into physical contact with the workpiece to be machined, so that the cutting elements penetrate into the workpiece to be machined and remove a material layer from the said workpiece.

In a special embodiment, the tool is rotated about its longitudinal axis for this purpose. Furthermore preferably, the tool is moved toward the workpiece or the surface of the workpiece to be machined in a translational movement. In this process, the cutting element, preferably cutting tooth, which is at the smallest distance from the distal end of the tool can create physical contact with the workpiece first. In this regard, the cutting tooth or cutting jaw penetrates into the workpiece and removes a groove-shaped notch. This notch can be further widened or reshaped, depending on the following cutting element, in other words the one at the second farthest distance. Particularly preferably, the edge of the groove is de-burred by the cutting jaw during this process.

In a special embodiment, the distal flank side of the cutting tooth first removes a material layer from the said workpiece; in particular, only the distal flank side of the cutting tooth removes the said material layer from the workpiece. The corresponding opposite flank of the groove to be thereby produced is formed by the proximal flank of a cutting tooth at a greater distance from the distal end.

In a special embodiment, the tool performs a helix shape. In this way, a thread structure can be milled on a workpiece using the tool. In a special embodiment, the thread is first pre-shaped by a drill, as a recess. In a subsequent step, the thread structure is removed and milled on the inner surface or the drill cylinder, using the tool according to the invention. By means of the solution according to the invention, an entire thread profile can be milled in one step.

In a special embodiment, the method is controlled electronically, using a CNC machine.

A further aspect of the present invention relates to methods for the production of a shaped part by means of material-removing machining of a workpiece, using a tool, in particular using a tool of the type described initially. The method comprises the step of contacting of the tool with the workpiece to be machined, so that cutting elements of the tool penetrate into the workpiece to be machined. A further step comprises that at least one cutting element structured as a cutting tooth removes a first recess that essentially corresponds to the shape of the said cutting tooth. In a further step, the method comprises that at least one cutting element configured as a cutting jaw removes a second recess. In the method according to the invention, the at least one cutting jaw is structured in such a manner that it is able to widen the wedge foot created by the cutting tooth, which is essentially wedge-shaped in terms of its profile side, at its widest location.

In a special embodiment, the tool and/or the workpiece describes a helix during the material-removing machining. In this regard, either the tool or the workpiece performs a spiral-shaped movement relative to the other. In an alternative embodiment, both the workpiece and the tool describe a helical movement relative to one another.

By means of the method according to the invention, a thread profile can be produced, for example, which is particularly precise and clean. Burrs are removed directly by the cutting jaw, at the first cut edge that is formed by the cutting tooth. With the correspondingly professionally adjusted control and helical guidance, a thread can thereby be produced in a single machining step, for example on a pre-drilled hole (in the case of an inside thread) or a bolt (in the case of an outside thread). Such controls are fundamentally known to a person skilled in the art, and can be adapted to the geometry of the tool, depending on the situation, in view of the thread to be produced.

In a special embodiment, cutting teeth and cutting jaws machine the workpiece successively, so that first recess edges created by a first machining cutting element, for example a first cutting tooth, are further removed by a successive machining step, by means of a different cutting element, for example a first cutting jaw.

In a special embodiment of the method, a first cutting tooth removes a first recess from a workpiece, and a second cutting tooth removes a second recess from the workpiece, which overlaps with the first recess, and a first cutting jaw removes a third recess from the workpiece, which overlaps with the first and/or the second recess.

In a special embodiment, a thread groove formed by one or more cutting teeth is de-burred and widened by means of a plurality of cutting jaws, which successively the groove edges, in that their edges, which correspond to the combined machining circumferences of the wedge feet cutting teeth, are removed by multiple cutting jaws at the opposite edge sides.

A further aspect of the present invention relates to a shaped part that comprises at least one helical profile notch. In a special embodiment, this shaped part has a thread, either an outside thread and/or an inside thread. This thread is characterized by a groove that can be obtained in that a workpiece is machined in material-removing manner, using the tool according to the invention.

In the following, the present invention will now be explained further using concrete exemplary embodiments and drawings, without being restricted to these. To a person skilled in the art, further advantageous embodiments, which are embodiments of the solution according to the invention, are evident from these examples.

The figures schematically show:

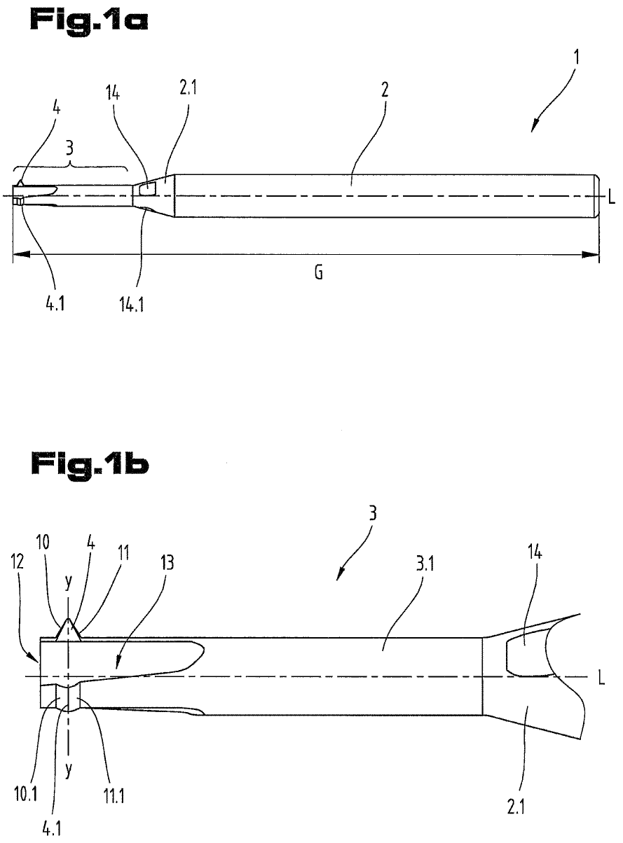

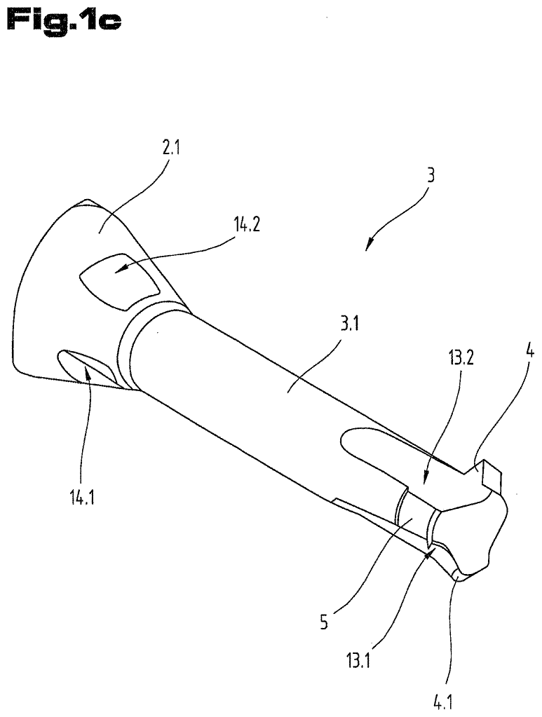

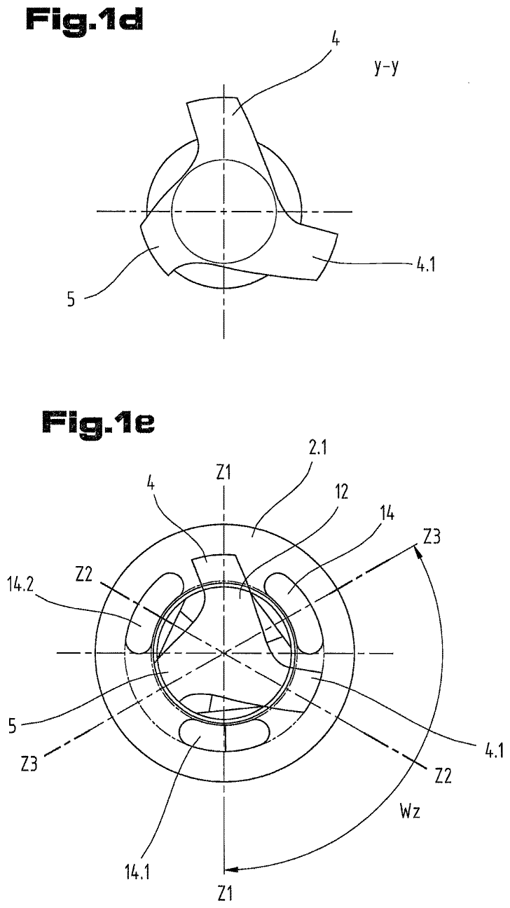

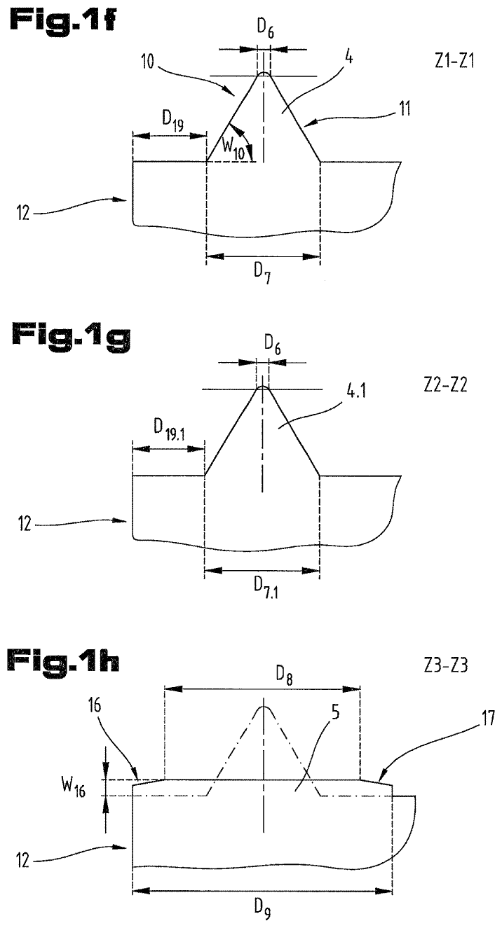

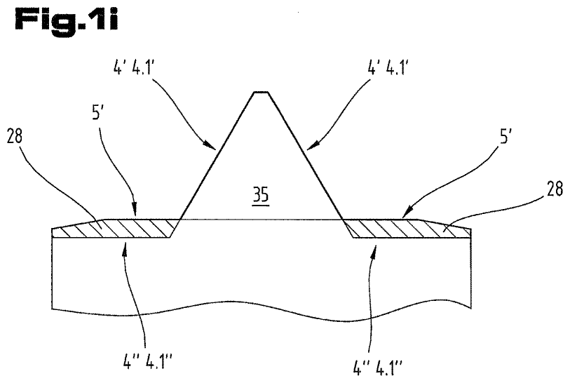

FIG. 1a a tool according to the invention;

FIG. 1b the tool head from FIG. 1a, enlarged;

FIG. 1c the tool head from FIG. 1b, in perspective;

FIG. 1d a cross-section through the section plane Y-Y from FIG. 1b;

FIG. 1e a tool according to the invention in a frontal view; FIG. if a first cutting element of FIG. 1a;

FIG. 1g a second cutting element of the embodiment from FIG. 1a;

FIG. 1h a cutting jaw from the embodiment of FIG. 1a;

FIG. 1i schematically, the cutting edge that can be achieved with the tool according to FIG. 1a;

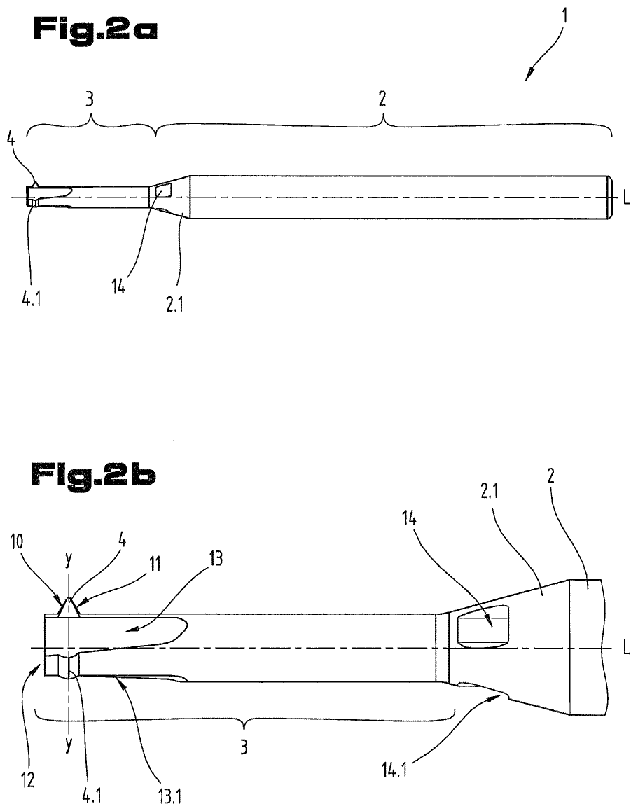

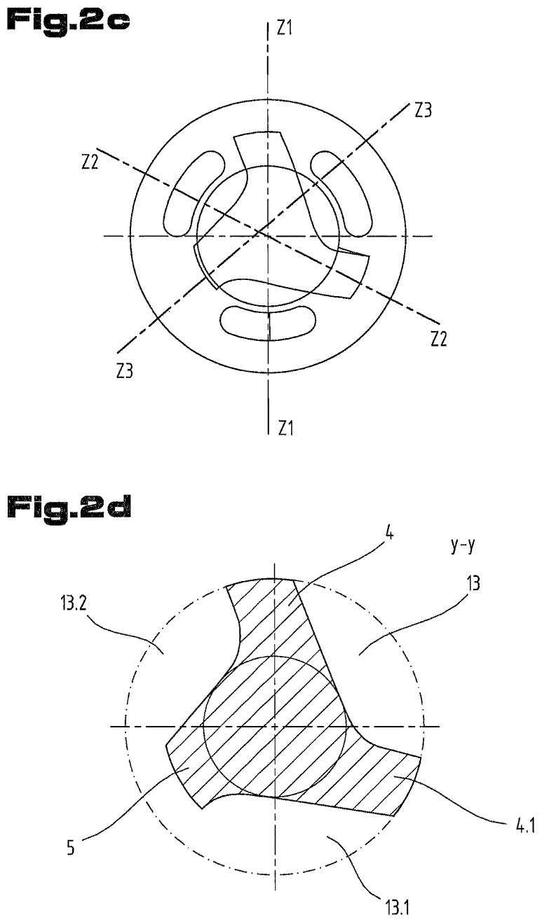

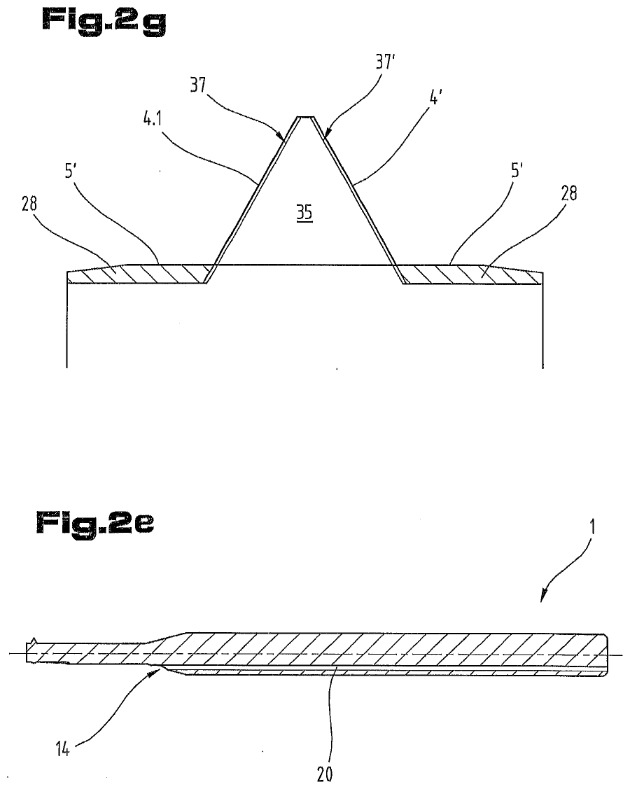

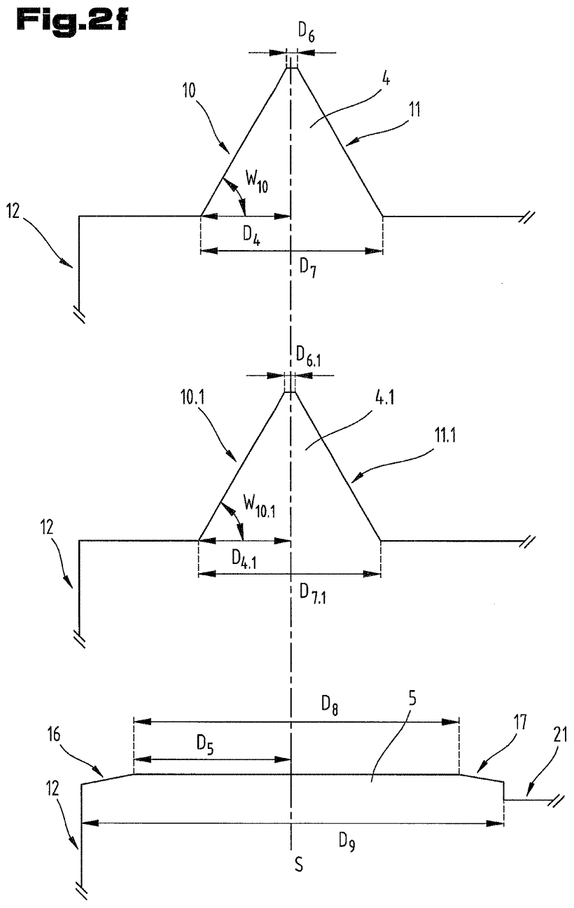

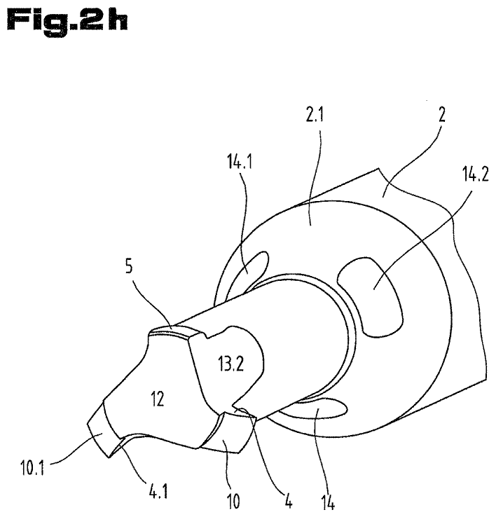

FIG. 2a an alternative embodiment of the tool according to the invention;

FIG. 2b the tool head of the embodiment of FIG. 2a;

FIG. 2c different section planes through the tool head of FIG. 2a;

FIG. 2d a cross-section through the section plane Y-Y of FIG. 2b;

FIG. 2f schematically, the cutting elements of the embodiment of FIG. 2a in relation to a perpendicular line S to the longitudinal axis;

FIG. 2g schematically, the overlaps of the cutting elements of FIG. 2a;

FIG. 2h schematically, the tool head of FIG. 2a in a perspective view;

FIG. 2i longitudinal cross-section through the tool from FIG. 2a;

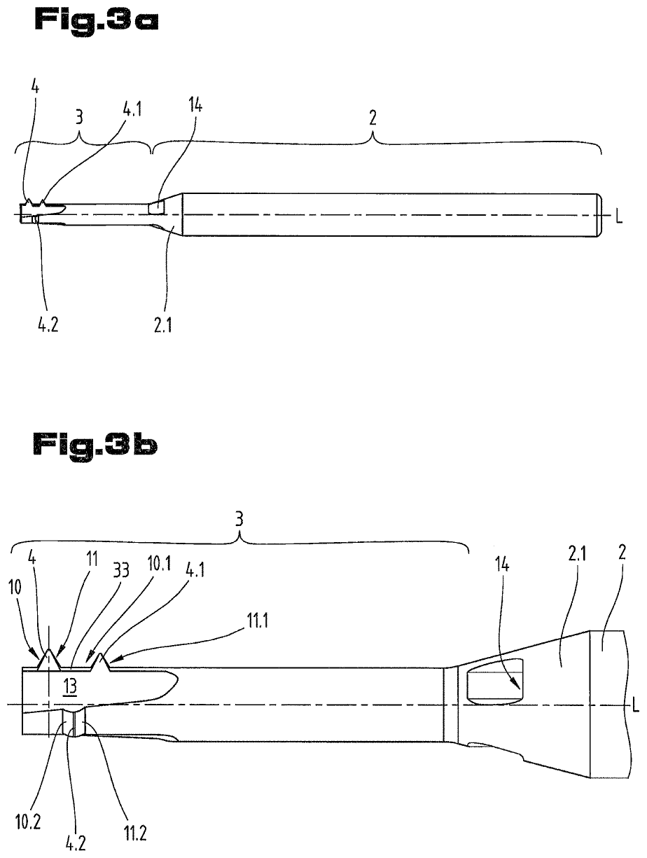

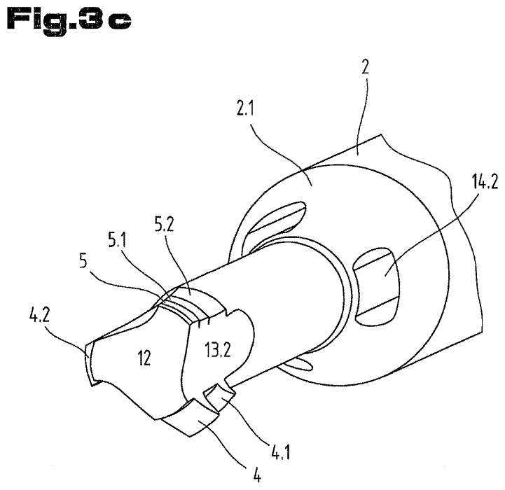

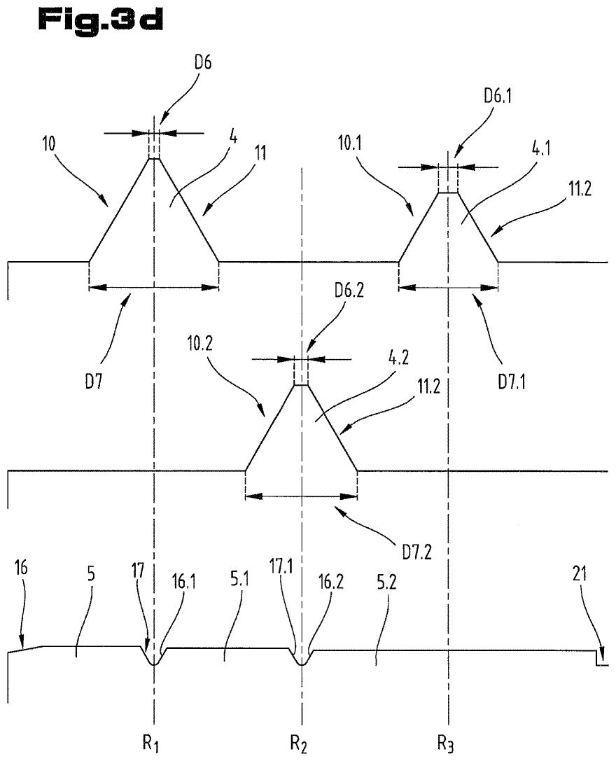

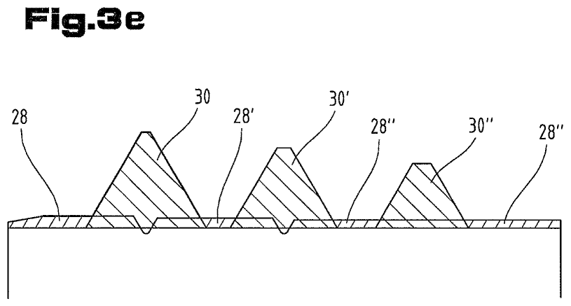

FIG. 3a a further alternative embodiment of a tool according to the invention;

FIG. 3b the tool head of the embodiment shown in FIG. 3a;

FIG. 3c perspective view of the tool head;

FIG. 3d schematically, the cutting elements of the embodiment of FIG. 3a in relation to a number of perpendicular lines relative to the longitudinal axis;

FIG. 3e schematically, an overlap of the cutting elements of the tool of FIG. 3a.

Unless explicitly mentioned otherwise, the analogous elements are represented with the same reference symbol in different figures, in each instance.

FIG. 1a shows a tool 1 according to the present invention, as an example. The tool can be roughly divided into two regions 2, 3, a shaft 2 and a tool head 3. The distal end is situated in the region of the tool head 3 and is formed by the farthest point in the longitudinal direction, while the proximal end is situated on the precisely opposite side on the shaft 2. In FIG. 1a, a longitudinal axis L is also shown, which runs through the center point of the circumference cross-section of the shaft 2 and, at the same time, forms the axis of rotation of the tool 1 during operation. The tool 1 shown in FIG. 1a can be used, for example, in order to mill a profile groove in a pre-drilled opening, or to mill an outside thread on a pin, in that the tool 1 is rotated about its longitudinal axis L and is guided translationally along a cylinder mantle of the said bore or the said pin by a drive, in a helical movement. The material-removing machining takes place at the tool head 3, and in the representation of FIG. 1a as shown, two cutting elements 4, 4.1, both of which are cutting teeth 4, 4.1, can be seen in the case of the tool head that is triangular in cross-section, overall. The tool 1 also possesses a cutting jaw, but in the representation shown, this cannot be seen. In the present example, the tool is structured in multiple parts. The tool head 3 is in one piece and consists of a particularly hard material, which is selected by a person skilled in the art in such a manner that it is at least harder than the material of the workpiece that is to be machined. The shaft 2 can be produced from a comparatively less expensive or lighter material. In the present example, the tool head 3 was connected with the shaft 2 by way of a shoulder 2.1. The shoulder 2.1 represents a narrowing of the shaft 2 toward the tool head 3. In the present example, the tool head 3 was locked into the shaft 2 by way of a bayonet closure. Fundamentally, however, all types of a shape-fit or force-fit connection are conceivable in the case of such a two-part tool 1. It is also possible to produce the entire tool 1 shown as a single-piece tool. A single-piece tool would have the advantage of increased stability. In the case of a two-part or multi-part tool 1, maintenance is easier and production of the cooling channels (not shown in FIG. 1a) is simpler. The exemplary tool 1 is made of steel and has a total length G of between 50 and 60 mm. Of course, the dimensions of the tool 1 are primarily determined by the intended machining. The values indicated are purely examples and can vary. The ranges do not represent any imprecision, but rather give a good basis for the exemplary tool, so as to be able to produce specific standardized threads. In a particularly concrete embodiment of the tool 1, the tool has a total length of 55 mm and a diameter of 4 mm (shaft diameter).

In FIG. 1a, two cooling openings can also be seen, which open out of the shoulder 2.1 and are disposed radially about the longitudinal axis L. The cooling openings 14, 14.1 open into cooling passages (not shown), which run parallel to the longitudinal axis L. During operation, a jet of coolant is sprayed to the tool head, parallel to the longitudinal axis, by means of the cooling openings 14, 14.1. Due to the rotation of the tool 1 about the longitudinal axis L, a radial coolant curtain is thereby formed, which optimally cools the material-removing process.

FIG. 1b shows an enlarged representation of the tool head 3 of the tool 1 from FIG. 1a. The tool head 3 begins with the end of the narrowing of the shaft in the form of a shoulder 2.1, forming a tool neck 3.1. The progression of the longitudinal axis L through the tool head 3 can also be seen. At the distal end of the tool head 3, there is a distal head surface 12. The cutting elements 4, 4.1 extend in wedge shape away from the tool head. Between the cutting elements 4, 4.1, there is a cutting gap 13, which simplifies material removal. In the present example, the wedge-shaped cutting teeth 4, 4.1 penetrate into the surface of the workpiece and peel a wedge-shaped groove out of it, wherein the chips are discharged by way of the cutting gap 13. In the present example, the tool neck 3.1 approximately corresponds to the depth of the thread to be produced. In the case of the upper cutting tooth 4 (based from the orientation in the figure), a face edge 10 and a rear edge 11 of the cutting tooth 4 can also be seen. The analogous second cutting tooth 4.1, which is offset from the first cutting tooth 4 by 120° in the clockwise direction, also has a face edge 10.1 and a corresponding rear edge 11.1. In the present exemplary tool, the placement of the cutting teeth 4, 4.1 is on the same plane perpendicular to the longitudinal axis. Likewise, the cutting teeth 4, 4.1 are of equal size. This means that the groove milled out by the cutting teeth 4, 4.1 during stationary rotation of the tool is congruent.

In this example, the cooling opening 14 is disposed essentially coaxially with the cutting gap 13.

Proceeding from the exemplary values of FIG. 1a, the tool head 3 is between 10-12 mm long. Tool heads having a length of 0.6 to 25 mm are usual for thread sizes in the size M0.3-M6, wherein the final configuration can be determined by a person skilled in the art using the machine requirements and the thread size to be produced.

FIG. 1c shows the tool head 3 from FIG. 1b in a perspective, frontal view from the distal end. In this perspective, the placement of the cutting elements 4, 4.1 and 5 is particularly clearly evident, proceeding from the distal end surface 12. The cutting elements 4, 4.1, 5 are disposed in a circular arrangement about the center point of the tool, spaced apart from one another by 120°. The perspective shown shows the cutting jaw 5 and two opposite cutting teeth 4, 4.1; the cutting gap 13.2 is situated between the cutting jaw 5 and the first cutting tooth 4. The cutting elements 4, 4.1, 5 are connected with the narrowing distal shaft end 2.1 by way of a tool head neck 3.1. Likewise, from this perspective view the coolant opening 14.2, which opens laterally on the narrowing distal shaft end 2.1, can be seen well. It is disposed in the same longitudinal plane as the cutting tooth gap 13.2, and during operation, this can lead to better distribution of the coolant. Analogously, a further cooling opening 14.1 is disposed coaxial with a further cutting gap 13.2. Although the cooling openings 13.1, 13.2 open laterally on the shoulder 2.1, the mouth leads to an axial coolant feed during operation.

FIG. 1d schematically shows the cross-section through the cutting elements of the tool head 3 from FIG. 1b in the section plane Y-Y. From this figure, the radial placement of the cutting elements 4, 4.1, 5 about the center point (the longitudinal axis L) and the resulting, essentially triskelion arrangement of the three cutting elements 4.1, 4.2, and 5 is particularly evident. The center points of the cutting elements are spaced apart from one another by about 120°.

FIG. 1e analogously shows a frontal view of the tool head and various section planes Z1-Z1, Z2-Z2, and Z3-Z3, which explain the individual cutting elements 4, 4.1, 5 of the tool of FIG. 1a in greater detail.

In the frontal view of FIG. 1e, the distal end of the tool head is formed by the distal head surface 12. Proceeding from this surface, three cutting elements 4, 4.1, 5 extend in the distal direction, two of which are configured as cutting teeth 4, 4.1 and one of which is configured as a cutting jaw 5. Three cooling openings 14, 14.1, 14.2 are disposed on the shoulder 2.1, radially around the center point L, which is situated on the longitudinal axis L. These are spaced apart from one another by an angle W_{Z} of 120 degrees. The cutting elements 4, 4.1, 5 extend outward from the tool head in the center of these angles, in other words spaced apart from one another by 120, in each instance, respectively spaced apart from the cooling openings by 60 degrees, so that an essentially triskelion shape of the tool head exists in a frontal view.

In Figure if, the section plane Z1-Z1 through a cutting tooth 4 is shown. The cutting tooth has an essentially wedge-shaped shape. In this regard, the wedge is formed by two flanks, a face flank 10 and rear flank 11, and ends in a round tip. The cutting tooth ridge is dimensioned as the distance of the two end points of the flanks 10, 11. This means that the ridge is dimensioned as the distance, in this example, where the face flank 10 and the rear flank 11 make a transition into the radius of the round tip. This cutting tooth ridge has a length D₆. The face flank 10 extends from the distal end of the tool head toward the cutting tooth ridge, at a specific angle W₁₀. In the present example, the angle W₁₀ is an angle of 60°. The edges that are formed when the cone impact form the points that are decisive for dimensioning the width of the cutting tooth root D₇. In the present example, the face edge 10 starts to extend upward from approximately 0.4 mm from the distal surface 12, at an angle W₁₀ of 60° to a parallel line of the longitudinal axis, and ends in a cutting tooth ridge having a width D₆ of 0.05 mm. The cutting tooth root D₇, which runs parallel to the cutting tooth ridge D6 in this example, has a width of 0.6 mm. In this concrete example, this cutting tooth 4 has a ratio between cutting tooth ridge and cutting tooth root of 1 to 12.

Analogously to this, the second cutting tooth 4.1 is shown in the section plane Z2-Z2 in FIG. 1g. This cutting tooth has the same dimensions as the cutting tooth 4 from FIG. 1f. The two cutting teeth are therefore essentially congruent. The distance D_{19.1} from the distal end to the face-side cutting tooth root is the same as the analogous distance D₁₉ of FIG. 1f, in other words approximately 0.4 mm from the distal end surface 12.

In FIG. 1h, the cutting jaw 5 of the corresponding tool 1 is shown in the section plane Z3-Z3. The cutting jaw 5 is also formed by a face edge 16 and a rear edge 17, which enclose an angle W_{w16} of 10° relative to a parallel line to the longitudinal axis. The edges 16, 17 form a cutting jaw ridge between them, having a width D₈. The starting edges of the edges 16, 17 form the cutting jaw root, having a cutting jaw root width D₉, by means of their distance. In the present example, the width of the cutting jaw root D₉ is 1.4 mm. The width of the cutting jaw ridge D₈ is 1.05 mm. The ratio between cutting jaw ridge and cutting jaw root amounts to approximately 1.3 (1.33 periodically) in the present example 1.

Therefore the ratio in the case of the cutting teeth 4, 4.1 is approximately ten times smaller, in comparison with the cutting jaws 5 in the embodiment of the example from FIG. 1a, in the case of the cutting teeth than in the case of the cutting jaws (1 to 12 vs. 1 to 1.3).

FIG. 1i shows a groove (bold solid line) milled out of the tool from FIG. 1a, in static rotation about the longitudinal axis, as an example. The machining tools 4, 4.1, and 5 successively penetrate into the material, and thereby (schematically) form a thread notch 35 with the surface 5′, 4′, 4′, 4.1′.

In this regard, in a first machining step, a groove having a first surface 4″/4.1″, 4′/′4.1′ is cut out by the cutting teeth, which rotate congruently. In a second machining step, an excess 28 is cut off from an edge of the groove by the cutting jaw. As a result, the thread groove 35 is widened and a clean cut edge is formed on the thread groove, with a new surface 5′.

An alternative embodiment of a tool 1 according to the invention is shown in FIG. 2a. This tool, too, is a tool 1 that extends in a longitudinal direction L, composed of a shaft 2 and a tool head 3. The shaft 2 narrows toward the tool head 3, in a shoulder 2.1, and has openings 14 for the feed of coolant during the machining process on this shoulder 2.1. The tool head ends, at its distal end, in a number of cutting elements 4, 4.1, 5 (the cutting jaw, No. 5, cannot be seen in this perspective). CH 706 934 (Mikron Tool SA Agno, CH) describes the arrangement of cooling channels on a milling tool, in which an exit opening of a fluid channel is disposed precisely below a shaft shoulder.

FIG. 2b correspondingly shows the tool head 3 in an enlarged representation, wherein the shaft 2 makes a transition into the shoulder 2.1, on which the cooling openings 14. 14.1 are situated. By way of a tool neck 3.1, the tool head 3 ends with a distal end surface 12 and the cutting elements 4, 4.1 at its distal end, wherein a first cutting element 4 has a face edge 10 and a rear edge 11. The section plane Y-Y will be explained in greater detail below, in FIG. 2d. This tool, too, has an essentially triskelion basic shape and a machining radius, wherein the cutting elements are disposed on the longitudinal axis around a centers point, spaced apart from one another at an angle of approximately 120° in the clockwise direction. The first cutting tooth 4 is followed by a cutting tooth gap 13 and a second cutting tooth 4.1, once again followed by a cutting tooth gap 13.1, and the cutting jaw 5, followed by a further cutting tooth gap 13.2.

A top view of this is shown in FIG. 2c, which also shows an essentially triangular arrangement of the cooling openings 14, 14.1, and 14.2 at the shaft narrowing 2.1. In FIG. 2c, the corresponding section planes through the cutting elements, Z1-Z1, Z2-Z2, and Z3-Z3 are also shown, which an offset [the noun Versatz=offset is used for the first time here; later in the document the noun Offset (obviously based on English) is also used; only one translation (offset) is possible for both] of the cutting elements is supposed to illustrate in greater detail, in connection with FIG. 2f.

FIG. 2d shows the aforementioned section plane Y-Y from FIG. 2b. The essentially triskelion arrangement of the cutting elements 4, 4.1, 5 and the cutting gaps 13, 13.1, 13.2 disposed between the cutting elements 4, 4.1, 5 are clearly evident.

For a better representation of the offset arrangement of the cutting elements 4, 4.1, 5 in contrast to the embodiment of FIG. 1a, in FIG. 2f the cutting elements are shown in relation to a perpendicular line S to the longitudinal axis and in relation to one another. For illustration purposes, the cutting teeth 4, 4.1, in particular, are shown one on top of the other. The perpendicular line S was selected in such a manner that it runs through the center point of the width of the cutting jaw 5.

The offsetting of the distal root base of the cutting elements 4, 4.1, 5 in relation to the perpendicular line S is shown as the offset D₄, D_{4.1} in FIG. 2f. In this regard, the first offset D₄ of the cutting tooth 4 is smaller than the second offset D_{4.1} of the second cutting tooth 4.1. During operation, this has the result that a thread groove having a first width is cut out by the first cutting tooth, while the thread groove is widened by the second cutting tooth and a second width is formed. In other words, only the shape of the face edge 10 and a corresponding cutting tooth ridge section of the resulting groove are determined by the first cutting tooth 4, while the shape of the rear edge 11.1 and the corresponding cutting tooth ridge section are determined by the second cutting tooth 4.1.

Alternatively or supplementally, widening of the thread groove can also by way of displacement of the tool, so that successive machining of the workpiece with a first and a second cutting tooth leads to widening of the said groove.

The cutting teeth are formed by their corresponding side edges 10, 11, 10.1, 11.1, which spread away from a parallel line to the longitudinal axis at angles W₁₀, W_{10.1}. The angles W10 and W10.1 are shown at 60° in this example. The ultimate shape of the cutting tooth and thereby the angles of the cutting tooth edges are, of course, dependent on the thread shape to be achieved, and can be adapted within the scope of the present invention by a person skilled in the art. In this embodiment, the cutting tooth ridge runs parallel to the longitudinal axis, as a straight line.

The first cutting tooth 4 has a ratio between cutting tooth ridge D₆ and cutting tooth root D₇ of 1 to 19. It has an offset D₄ from the perpendicular line that is smaller than a second offset D_{4.1} of the second cutting tooth 4.1 from the perpendicular line S. The second cutting tooth has a ratio between cutting tooth ridge D_{6.1} to cutting tooth root D_{7.1} of 1 to 19.

In the case of the cutting jaw 5, the perpendicular line S runs through the center of the width of the cutting tooth jaw D₉ and of the corresponding cutting jaw ridge D₈. A cutting jaw offset D₅ corresponds to half the distance D₈, respectively Dg. The ratio between cutting jaw ridge D₈ and cutting jaw root D₉ amounts to approximately 1 to 1.35. As in the preceding example, these ratios and dimensions are merely indicated as examples, and the real dimensions of a concrete embodiment can be determined and selected by a person skilled in the art based on the situation, based on the desired thread size.

The cutting jaw 5 possesses a face edge 16 and a rear edge 17, which ends in a notch 21, which extends into the tool neck (not shown).

The sequence of this arrangement is illustrated using a schematic groove in FIG. 2g. The first cutting tooth 4 having the offset in the proximal direction with regard to the perpendicular line S forms the edge 4′. Offsetting of the cutting teeth 4, 4.1 relative to one another leads to the result that the entire recess 35 of the groove is formed by the overlap of the two cutting teeth and additionally the offsets 37, 37′ on both sides. Thus, a first offset 37 is formed by the face edge of the second cutting tooth, and second offset 37′ is formed by the rear edge of the first cutting tooth.

In order to obtain a groove as shown in FIG. 2g, the cutting teeth are therefore structured, in total, in such a manner that they are narrower than the groove. Because of the offset of the cutting teeth with regard to the perpendicular line, an additional offset is removed and the cutting teeth describe different rotation circumferences. The face-side groove flank is formed by the second cutting tooth 4.1, while the proximal groove flank 4′ is formed by the first cutting tooth.

The groove is further widened at its side edges by the cutting jaw(s), in that these remove the excess 28.

The machining described takes place successively during the rotation of the tool. In use, however, this is more complex, since in general, the tool is helically moved in the thread direction when producing a thread. By means of the tool according to the invention, to cut and de-burr using a single work step. The resulting profiles are particularly precise and essentially free of burrs.

The description of the work sequence and the numbering of the individual cutting elements takes place for a better illustration in this application. In operation, however, the sequence of the machining plays no role and it is very complicated to control it, in any case, since the tool is rotating rapidly.

Analogous to the embodiment of FIG. 1, in this example, too, an excess 28 is cut off by the cutting jaw, so that widening of the groove takes place, with simultaneous de-burring of the cut edge that is produced by the cutting teeth. This process, too, can take place successively.

FIG. 2h schematically shows a tool head from the embodiment of FIG. 2a in a perspective view, wherein the three cutting elements 4, 4.1, and 5 can be particularly well seen in their triskelion arrangement. The cutting tooth 4 and the cutting jaw 5 enclose a cutting tooth gap 13.2 in the radius, which gap lies on the same plane as an essentially half-moon-shaped cooling opening 14.2 in the longitudinal direction. As a result, in the process coolant can optimally reach the machining location, and chip discharge can take place more easily. Likewise, the further cooling openings 14, 14.1 arranged with the corresponding cutting tooth gaps are also disposed on the shoulder 2.1 of the shaft 2. In the clockwise direction, the cutting elements 5, 4, 4.1, the cutting jaw 5, the cutting tooth 4 with its face edge 10, and the cutting tooth 4.1 with its face edge 10.1 can be seen.

For machining of particularly hard materials, the tool head or at least the cutting elements can be provided with a particularly abrasion-resistant coating. In the concrete example, the cutting tooth head consists of hard metal and was provided with a titanium nitride layer. This ceramic coating is particularly hard and corrosion-resistant and resistant to wear.

Using the solution according to the invention, it is also possible to produce complex threads having different thread sizes that run parallel.

FIG. 2i shows the placement of the cooling channels 20 in a longitudinal cross-section through the tool from FIG. 2a, using a concrete example. The cooling channel 20 extends from the proximal end of the tool 1 to the narrowing of the shaft, and there opens laterally into a coolant opening 14.

A particular, further alternative embodiment is shown in FIG. 3a, where a tool 1 is shown having a shaft 2 that extends in the longitudinal direction L and ends in a tool head 3, and is connected with the latter by way of a shoulder 2.1. In this embodiment, too, lateral coolant openings 14 are disposed on the shoulder 2.1. The tool head ends in a number of cutting teeth 4, 4.1, 4.2, and furthermore cutting elements that cannot be seen from this perspective.

Although the tools shown as examples all follow an essentially triskelion arrangement, quadragonal, pentagonal or hexagonal cross-sections are also certainly conceivable.

FIG. 3b shows the tool head once again, on a larger scale, where the individual cutting elements 4, 4.1, and 4.2 can be seen particularly well in their relationship to one another. Two first cutting teeth 4, 4.1 are situated on a first machining axis parallel to the longitudinal axis, while a third cutting tooth 14.2 is disposed on a second machining axis parallel to the longitudinal axis. The tool head 3 makes a transition into a shoulder 2.1 in the longitudinal direction L, from its proximal end, on which shoulder coolant openings 14 are disposed. At its distal end, it first has a first cutting element 4, having a first face edge 10 and a first rear edge 11. At a distance 33, a second cutting edge 4.1 having a second face edge 10.1 and a second rear edge 11.1 now follows in the same longitudinal plane.

A third cutting tooth 4.2 is disposed at a distance of a tooth gap 13, which tooth has a distance from the distal end surface of the tool head 3 that is greater than that of the first cutting tooth 4. In this embodiment, this third cutting tooth 4.2 would come to lie precisely in the gap between the first cutting tooth 4 and the second cutting tooth 4.1. This third cutting tooth also has a face edge 10.2 and a rear edge 11.2.

FIG. 3c shows the tool head of FIG. 3a in a perspective view.

The essentially triskelion arrangement of the cutting elements 4, 4.2, and 5 can also be seen. It can also be seen that the cutting elements 4, 4.1 are disposed offset from one another in terms of their axis. The cooling openings 14, 14.1, and 14.2 are disposed on the shoulder 2.1 at a distance of 120°.

In FIG. 3d, the cutting elements 4, 4.1, 4.2, 5, 5.1, and 5.2 are shown schematically in relation to one another and with reference to three perpendicular lines R₁, R₂ and R₃. The perpendicular lines R1, R2, and R3 represent perpendicular planes relative to the longitudinal axis of the tool.

From the distal end, the first cutting element is a first cutting jaw 5, which is formed by a face edge 16 and a rear edge 17. Next, a first cutting tooth 4 follows, running through the center point of the first rotation radius, having a face edge 10 and a rear edge 11. The first cutting tooth has a cutting tooth ridge D₆ and a cutting tooth root D₇. The ratio of the width between the cutting tooth ridge D₆ and the cutting tooth root D₇ amounts to 1:13 in this case. The next cutting element is a second cutting jaw 5.1, which is disposed between the two perpendicular lines R1 and R2 and formed by a face edge 16.1 and a rear edge 17.1. The fourth cutting element is a second cutting tooth 4.2, which has a lesser volume than the first cutting tooth 4. This cutting tooth also has a face edge 10.2 and a rear edge 11.2. This cutting tooth also has a width of the cutting tooth wheel D_{6.2} and a width of the cutting tooth root D_{7.2}. In this case, the ratio is 1:9.25.

A third cutting jaw 5.2 follows, having a face edge 16.2. This cutting jaw possesses no rear edge, but rather ends directly in a notch 21 following the tool neck (not shown). A last, third cutting tooth 4.1, which has a smaller volume than the cutting tooth 4.2, concludes the cutting elements and has a face edge 10.1 and a rear edge 11.2. The ratio between the width of the cutting tooth ridge D_{6.1} and the width of the cutting tooth root D_{7.1} amounts to 1:5.33 in this case.

It is shown schematically in FIG. 3e how a tool head arranged in this manner is able to machine a workpiece. The cutting teeth engage into the workpiece in such a manner that the recesses of the thread groove 30, 30′, 30″ are formed. The excesses 28, 28′, 28″ at the edges of the thread grooves are further removed by subsequent machining of the cut edges by the cutting jaws. De-burred, highly precise, and clean threads are produced.

In this regard, the cutting jaws are always arranged in such a manner that they a successive machining step after engagement of the cutting teeth, an excess that remains at the edges formed by the cutting teeth is removed. Also, the cutting teeth are arranged in such a manner that they together can form a single, continuous thread groove, which extends in spiral shape along a workpiece, during successive machining, either by means of an offset relative to a perpendicular line relative to the longitudinal axis of the tool, or by means of different cutting tooth geometries, in other words variation of the cutting tooth ridge width and cutting tooth root width. This can be achieved by way of the geometry of the tool, as described here, in combination with control of the tool, as is already known.

The concrete embodiments shown in this application are intended to show possibilities within the inventive concept as examples, and to illustrate the invention. Of course, individual characteristics from the individual embodiments can be combined with one another as desired, if they thereby form a practical tool for material-removing machining of a workpiece. Even alternatives that are not shown, having quadragonal, pentagonal or even hexagonal profile cross-sections, as well as curves, are conceivable.

1. A tool (1) for material-removing machining of a workpiece, wherein the tool (1) has a proximal and a distal end, the tool furthermore comprising:
a) a shaft (2) for connecting the tool (1) with a drive in the region of the proximal end;
b) a tool head (3) in the region of the distal end;
c) cutting elements (4, 4.1, . . . , 4.5, 5, 5.1, . . . , 5.3) on the tool head (3), wherein the cutting elements (4, 4.1, . . . , 4.5, 5, 5.1, . . . , 5.3) are structured in such a manner that they are able to penetrate into the workpiece to be machined and able to remove a material layer from the said workpiece, and wherein
d) the cutting elements (4, 4.1, . . . , 4.5, 5, 5.1, . . . , 5.3) furthermore comprise at least one cutting tooth (4, 4.1, . . . , 4.5) having a cutting tooth ridge (D₆, D_{6.1}, . . . D_{6.5}) and a cutting tooth root (D₇, D_{7.1}, . . . D_{7.5}) and at least one cutting jaw (5, 5.1, . . . , 5.5) having a cutting jaw ridge (D₈, D_{8.1}, . . . D_{8.5}) and a cutting jaw root (D₉, D_{9.1}, . . . D_{9.5}), and
wherein the ratio between cutting tooth ridge (D₆, D_{6.1}, . . . D_{6.5}) and cutting tooth root (D₇, D_{7.1}, . . . D_{7.5}) is smaller than the ratio between cutting jaw ridge (D₈, D_{8.1}, . . . D_{8.5}) and cutting jaw root (D₉, D_{9.1}, . . . D_{9.5}), in particular 2 to 10 times smaller.

2. The tool (1) according to claim 1, wherein the ratio between cutting tooth ridge (6, 6.1, . . . 6.5) and cutting tooth root (7, 7.1, . . . , 7.5) lies in a range of between 1 to 2 and 1 to 25, preferably of between 1 to 5 and 1 to 20, further preferably of between 1 to 10 and 1 to 15.

3. The tool (1) according to claim 1, wherein the ratio between cutting jaw ridge and cutting jaw root lies in a range of between 1 to 1 and 1 to 1.9, preferably of between 1 to 1.1 and 1 to 1.75, particularly preferably of between 1 to 1.3 and 1 to 1.5.

4. The tool (1) according to claim 1, wherein the at least one cutting tooth ridge is structured in such a manner that it defines a first machining radius during a rotation of the tool about its longitudinal axis, and wherein the at least one cutting jaw ridge (D₈, D_{8.1}, . . . D_{8.5}) is structured in such a manner that it defines a second machining radius during a rotation of the tool about its longitudinal axis, and, in particular, wherein the first machining radius is greater than the second machining radius.

5. The tool (1) according to claim 1, wherein the cutting jaws are structured in such a manner that the cutting jaw ridges project beyond the cutting tooth root rotation circumferences in terms of their cutting jaw rotation circumference by the longitudinal axis (L), so that a first edge formed by the cutting tooth roots is removed from the workpiece by the width of the cutting jaws, in particular that in this way, an excess (28) is removed.

6. The tool (1) according to claim 1, wherein the at least one cutting tooth has a face edge (10) and a rear edge (11).

7. The tool (1) according to claim 1, wherein the tool comprises a plurality of cooling channels, which extend through the shaft parallel to the longitudinal axis (L) of the tool.

8. The tool (1) according to claim 7, wherein the shaft (2) narrows toward the tool head (3), so that a shoulder (2.1) is formed, and the cooling channels (20) have cooling openings (14, 14.1, 14.2) on this shoulder (2.1), and, in particular, wherein the cooling openings (14, 14.1, 14.2) extend radially around a longitudinal axis (L) of the tool on this shoulder (2.1), in particular wherein the cooling openings (14, 14.1, 14.2) have an essentially half-moon shape.

9. The tool (1) according to claim 1, comprising coolant openings (14, 14.1, 14.2), which are disposed on the tool (1) axially relative to the longitudinal axis and coaxial with a cutting gap (13, 13.1, 13.2).

10. The tool (1) according to claim 1, comprising a plurality of cutting teeth (4. 4.1, 4.2), and wherein at least a first cutting tooth (4) is disposed relative to a second cutting tooth (4.1, 4.2) in such a manner that the first and the second cutting tooth have an overlapping but not congruent rotation circumference (30, 30′, 30″) about the longitudinal axis (L).

11. The tool (1) according to claim 1, comprising a plurality of cutting jaws, and wherein at least a first cutting jaw is disposed relative to a second cutting jaw (5.1, 5.2), in such a manner that the first and the second cutting jaw have an overlapping rotation circumference with at least one cutting tooth.

12. The tool (1) according to claim 1, wherein the tool is coated with an abrasion-resistant layer, in particular the tool head is coated with an abrasion-resistant layer.

13. A method for the production of a shaped part by means of material-removing machining of a workpiece using the tool (1) according to claim 1, comprising the steps:
a) contacting the tool with the workpiece to be machined, so that cutting elements of the tool penetrate into the workpiece to be machined, and wherein
b) at least one cutting element structured as a cutting tooth removes a first recess (30, 30′, 30″), which essentially corresponds to the shape of the cutting teeth, and
c) at least one cutting element configured as cutting jaws removes a second recess (28, 28′, 28″), and
characterized in that
the at least one cutting jaw is structured in such a manner that it is able to widen the wedge foot created by the cutting tooth, which is essentially wedge-shaped in terms of its profile side, at its widest location.

14. The method according to claim 13, wherein cutting teeth and cutting jaws successively remove the material, so that first recess edges created by a first machining cutting element are further removed by a successive machining step, by means of another cutting element.

15. The method according to claim 13, wherein a first cutting tooth removes a first recess from a workpiece, and wherein a second cutting tooth removes a second recess from the workpiece, which recess overlaps with the first recess, and a first cutting jaw removes a third recess from the workpiece, which overlaps with the first and/or the second recess.

16. A shaped part that can be obtained by means of the method according to claim 13, wherein the shaped part has at least one helical profile notch.
